(19) United States
(12) Patent Application Publication
(10) Pub. No.: US 2022/0284366 A1
(43) Pub. Date: Sep. 8, 2022

(54) METHOD AND SYSTEM FOR MANAGING A CRANE AND/OR CONSTRUCTION SITE

(71) Applicant: GLOBAL ENGINEERS TECHNOLOGY PTE. LTD., Singapore (SG)

(72) Inventors: Bernard KELLY, Mittagong, New South Wales (AU); Damon HANLIN, Kellyville, New South Wales (AU)

(73) Assignee: GLOBAL ENGINEERS TECHNOLOGY PTE. LTD., Singapore (SG)

(21) Appl. No.: 17/631,931

(22) PCT Filed: Jul. 30, 2020
(86) PCT No.: PCT/SG2020/050437

§ 371 Date: Feb. 1, 2022

(30) Foreign Application Priority Data
Aug. 2, 2019 (SG) 10201907179Y
Jun. 17, 2020 (SG) 10202005748Q

(51) Int. Cl. G06Q 10/06; B66C 13/16; B66C 23/88; B66C 13/18; G06V 20/00

(52) U.S. Cl. CPC G06Q 10/06311; B66C 13/16; B66C 23/88; B66C 13/18; G06V 20/38

(57) ABSTRACT

An apparatus for managing a construction site comprises a memory storing sensor data received from a plurality of capture devices associated with the construction site. The memory stores one or more rules or thresholds. A processor is configured to process the sensor data by evaluating at least one of the rules, or by comparing a prediction computed from the sensor data with at least one of the thresholds. The processor is configured, in response to evaluation of a rule, or in response to comparison of a prediction with a threshold, to trigger an alert.

### TECHNICAL FIELD

The present invention relates to a method and system for managing a crane and/or a construction site.

### BACKGROUND

A modern crane is a complex piece of machinery that has many critical components and systems that may or may not communicate with each other making a crane difficult to manage.

Construction sites are also complex and difficult to manage. Construction sites are typically safety critical environments where it is extremely important to have good management in order to maintain the safety of construction workers. Good management is also crucial to enable effective planning, productivity, site management and budget control.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is an apparatus for managing a construction site and/or crane, the apparatus comprising a memory storing sensor data received from a plurality of capture devices associated with the construction site and/or crane. The memory stores one or more rules or thresholds. A processor is configured to process the sensor data by evaluating at least one of the rules, or by comparing a prediction computed from the sensor data with at least one of the thresholds. The processor is configured, in response to evaluation of a rule, or in response to comparison of a prediction with a threshold, to trigger an alert.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 illustrates a representation of a construction site management apparatus;

FIG. 2 illustrates a schematic view of a software system for carrying out an embodiment;

FIG. 3 illustrates a representation of a network of data processing systems in which aspects of the disclosed embodiments are implemented;

FIG. 4 is an overall view of a system for managing a crane in accordance with an embodiment of the invention;

FIG. 5 illustrates a method of managing an event in accordance with an embodiment of the invention;

FIG. 6 is a flow diagram of a method of addressing a problem identified at a construction site;

FIG. 7 is a schematic diagram of two cranes and indicating sensors on the cranes;

FIG. 8 is a flow diagram of a method of operation at a construction site management apparatus;

FIG. 9 is a flow diagram of a method of operation of a trained object recognition system;

FIG. 10 is a flow diagram of a method of operation at a construction site management apparatus;

FIG. 11 is a flow diagram of a method of gap analysis;

FIG. 12 is a flow diagram of a method of use of satellite images;

FIG. 13 is a flow diagram of a method of predicting an occupational health and safety accident.

### DETAILED DESCRIPTION

The various configurations discussed in these non-limiting examples can be varied and are used to illustrate at least one embodiment and are not intended to limit the scope thereof.

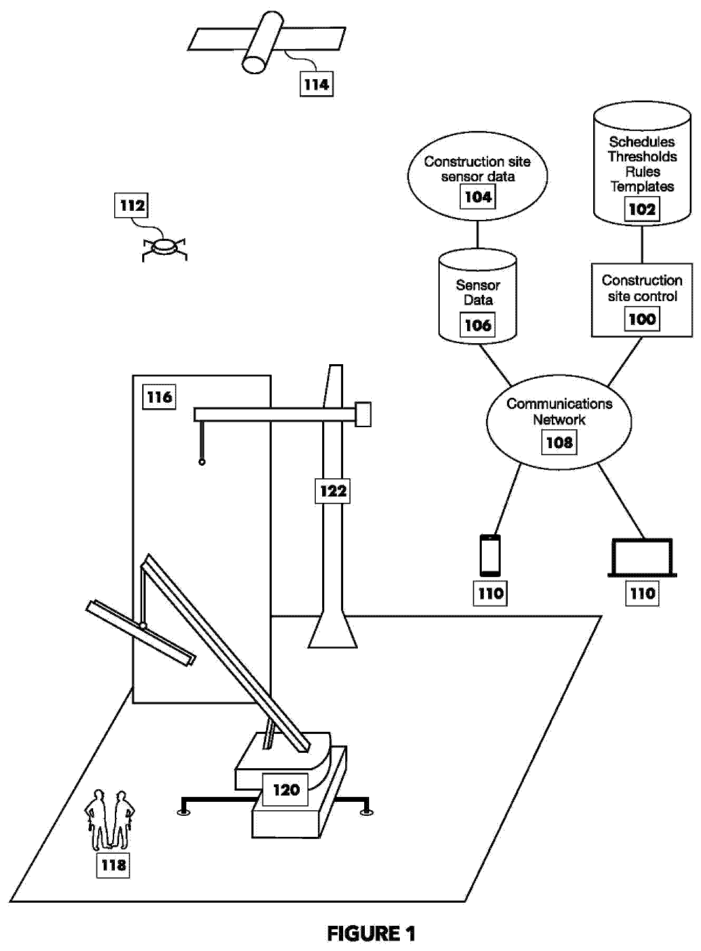

FIG. 1 shows a construction site comprising a building 116 under construction, a tower crane 122, a mobile crane 120 and site engineers 118. One or more capture devices sense data about the construction site. A non-exhaustive list of capture devices which are used is: drone 112 with camera, satellite 114, video camera located on a crane, temperature sensor, wind sensor, pressure sensor, light sensor, humidity sensor, traffic camera, strain gauge. The capture devices are in or around the construction site.

Construction site sensor data 104 is communicated from the individual capture devices to a sensor data store 106 by wired or wireless communication. The sensor data is batched, time stamped and in some cases is compressed in order to reduce bandwidth needed to communicate the sensor data.

A construction site management apparatus 100 has access to the sensor data 106 via a communications network. In some cases the construction site management apparatus 100 is deployed as a web service although that is not essential. The construction site management apparatus 100 has access to a store 102 of schedules, thresholds, rules and templates which are pre-configured. The construction site management apparatus 100 is able to send control messages to the cranes 120, 122 enabling remote control of the construction site equipment. The construction site management apparatus 100 is also able to send messages to end user client devices to facilitate control of construction site equipment and of the construction site itself. The construction site management apparatus 100 is accessible by one or more client devices 110 including client devices of site engineers 118. Information about the construction site management is available to end users via the client devices.

The construction site management apparatus 100 is implemented using a computer 200. The computer 200 includes other components that are omitted for brevity without departing from the embodiments of the invention as described. The computer 200, which may interchangeably be referred to as a user device, includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store processor instructions utilized to configure the computer 200 to perform processes including processes in accordance with embodiments of the invention and/or data for the processes being utilized. In other embodiments, the software and/or firmware can be stored in any of a variety of non-transitory computer readable media appropriate to a specific application.

The communications network 108 of FIG. 1 refers to any contact between the parties described and is accomplished through any suitable communication means, including, but not limited to, a telephone network, public switch telephone network, intranet, Internet, extranet, WAN, LAN, point of interaction device, point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

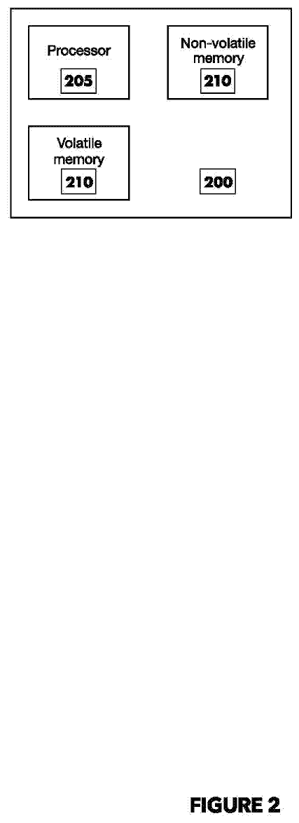

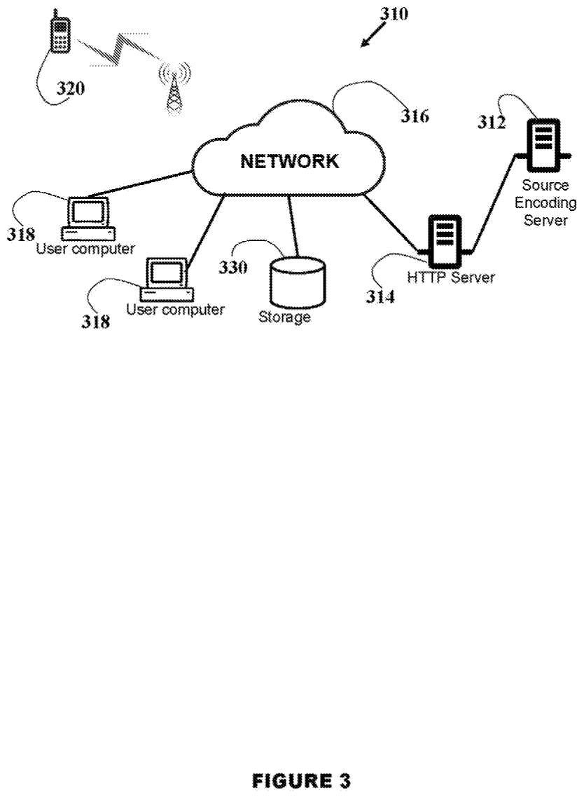

FIG. 3 illustrates a representation of a network of data processing systems in which aspects of the disclosed embodiments are implemented. FIG. 3 shows a recording system whereby data monitored by sensors associated with a crane and/or a construction site is recorded at storage 330 and/or servers 312, 314. The network of data processing systems 310 includes a server 312. In other embodiments, the server 312 can be any processing device including a processor as depicted in FIG. 2 and including sufficient resources to perform the process of storing and processing sensor data received from a crane system and/or construction site. The server 312 is connected to an HTTP server 314. HTTP server 314 uses HTTP or any other appropriate stateless protocols to communicate via a network 316 such as the Internet, with any other device connected to the network 316.

In the illustrated embodiment of FIG. 3, the user devices 318 correspond to the computer 200 of FIG. 2. In FIG. 3, the user devices include personal computers 318, consumer electronics (CE) players, and mobile phones 320. In other embodiments, user devices include consumer electronic devices such as televisions, set top boxes, video game consoles, tablets, and other devices that are capable of connecting to a server via HTTP and playing back encoded media. A storage unit 330, which is in the form of memory, databases etc., is in communication with a communications network 316. Although a specific architecture is shown in FIG. 3, any of a variety of architectures including systems that perform conventional processes can be utilized that enable playback devices to request portions of a top level index file and container files in accordance with embodiments of the invention.

Some processes for providing methods and systems in accordance with embodiments of this invention are executed by a user device or user mobile device. The relevant components in a playback device that can perform processes including adaptive streaming processes in accordance with embodiments of the invention are as shown in FIG. 2.

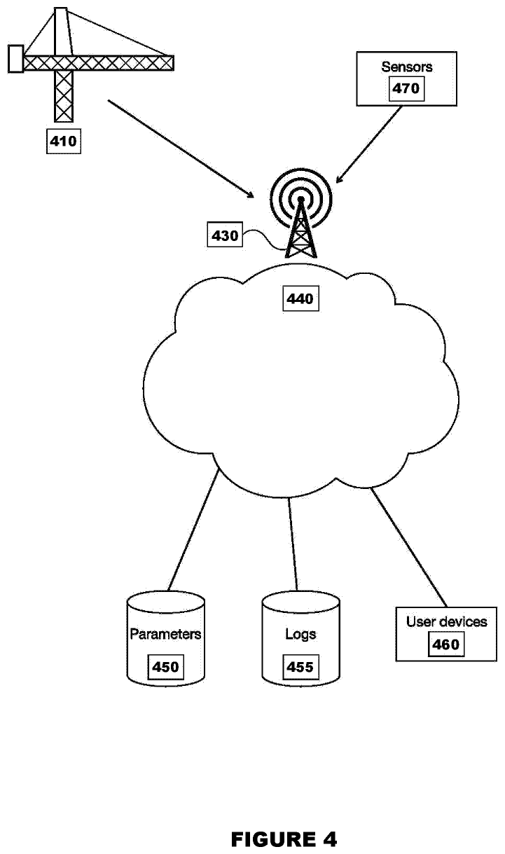

FIG. 4 shows the overall architecture of a management system which shows a crane system 410 with all its data and information from various sensors. The sensors are one or more of: sensors for weight, tilt, positioning, sensors for crane diagnosis, sensors to detect parts and sensors to detect presence of items in inventory lists, temperature sensors, and even an employee timesheet system. Although not shown, the management system comprises a camera monitoring system for providing images depicting at least one of a view from the crane, a view of the crane, a view from the construction site or a view of the construction site.

The crane system 410 communicates with a router 430 that is linked to a server, possibly located in a cloud 440. Information from other devices or sensors such as crane anti-collision monitoring systems (DCS60-SUP) (SMIE) 440 can also be transmitted to the router 440.

The server also communicates with processors, databases and servers that control and maintain various parameters, including individual parameters used by a crane 450; central logs for a crane 455; and information for all, user devices 460. The crane parameters 450 and logs 455 can also be hosted to allow for an active connection with the crane 450, which is useful for trouble shooting or problem rectification remotely. At the same time, a security system is also in place to ensure that remote access is only granted to authorized users, including the client, the crane operator, the crane manufacturer, or a crane maintenance crew, with varying levels of access if required.

The central logs 455 for a crane 410 can be recorded live, or periodically (every few seconds) and each movement of the crane 410 is recorded, logged, and time-stamped, along with the amount of load carried, radius, time taken, and environmental conditions such as wind speed and ambient temperature. The temperature of various points of the crane 410 can also be recorded via temperature sensors. The system is able to generate graphs to present information such as load spectrum and movement spectrum of the crane. Special logs can be created for alarms or events such as emergency stop, where the system can capture the location of the emergency button that was activated. In the case of alarms by the system, such as a wind alarm, the system can upload it immediately and provide an alert via email or telephone communication systems to relevant parties, including clients if needed. A requirement can be put in place to review each alarm to ensure safety is not compromised. The log would then capture details of the review of the alarm for record keeping, including details of the reviewer of the alarm. Alarm messaging options include wind speed velocity, moment overload, working range limits, erection mode where bypass is activated, emergency stop (by location), or anti-collision override. Other parameters that can be controlled and monitored by the system can include power consumption of the crane, current draw of each motor and VF drive, monitoring of the anti-collision system (also known as an SMIE anti-collision system) and faults from the crane Programmable Logic Controller (PLC). The SMIE anti-collision system is a safety and/or driver assistance device for the management of the tower crane operations on construction sites, especially those with two or more cranes. It helps the crane operator to anticipate the risk of collision between the moving parts of his crane and those of the neighboring crane. When a risk of collision is detected, the system “takes over” and automatically slows down to a stop the hazardous movements.

The start-up checklist is an electronic form that is filled in by qualified personnel (e.g. Crane Pre Start Daily Check), and may require data to be recorded prior to starting-up the crane (Pre-start) without this data being entered the crane would not commence work. This can include checking the oil levels of the various motors or engines or brakes, lubrication of various parts including gears and slewing ring, testing of critical components, checking the reeving system, emergency systems check and accounting for, and any other visual inspection of the crane structure and its components. Aside from logging in to the system, this form can also incorporate an electronic sign off to ensure accountability.

Other information captured by the central log 455 includes crane calibration, crane configuration, slack rope, mechanism cycles log, load spectrum log, emergency stop button log, last events (including load and moment), and alarm logs with email notification and review or checking box for events such as moment overload, working range limits, erection mode (bypass activated), and emergency stop. Also, the system can integrate an electronic log book to record number of hours in operation for its servicing cycle, typically monthly, and when required, trigger an alarm or alert to have the crane serviced, along with the site report. Along with the servicing report, an inventory or parts log of the various components of a crane 410 can also be kept to ensure servicing and periodic inspections or replacements are carried out. Other parts of the system such as the camera monitoring system can also be integrated into the system and allow online or live camera access remotely. Employees' timesheets can also be tracked and monitored by the system. The system can include report generation functions that allow for easy generation of reports to account for the usage of the crane 410.

Inputs that the system processes, logs, and records can include lifting schedule, camera on hoist rope termination point, camera on winch pack (drum or rope), aviation light monitoring, crane balance/deflection reading, motor or engine temperature, RPM of motor or engine, crane data such as radius, hook height, weight, slew orientation, and windspeed, line pull monitor, moment limit monitor, break pads wearing switch, individual inputs for monitored items on PLC. Some of the cameras may also incorporate image recognition to automatically highlight or alert if there any issues in the object being monitored, for example if the rope is damaged, the camera on the winch pack may see and recognize this and trigger an alert.

One of the critical items in the operation and safety of a tower crane is the termination rope, thus monitoring this using a camera would ensure that the ropes are correctly terminated. Some embodiments may also incorporate the operation of this camera into the start-up check list, and in the case where the camera or sensor monitoring the termination rope is not functioning correctly, the system would not allow the crane to begin operations and commence shut down procedures of any components already in operation. The cameras or sensors used can also allow for remote maintenance or even automatic preventive maintenance that would highlight or alert any abnormality in the rope(s) such as snapped strand or over twisted wire rope, and trigger necessary actions if required, including remote access screening.

The monitoring of aviation lights is required due to the height of tower cranes which can present hazards to low flying aircraft. This is especially critical when the tower crane is sited near airports, hospitals, military bases, or heliports. Should there be a problem in the aviation lights, appropriate action by the system may include halting crane operations and notifying the relevant authorities.

Other system inputs also include slew angle monitoring which assists in aligning the crane prior to climbing or addition of extra frame work to gain height. This helps the PLC logic for crane radius measurement as well as on crane capacity chart correction.

One of the outputs of the system is a crane monitoring diagram, that will assist remote access and provide an overview of the crane and its data collected. This can also be hosted or displayed and in communication with a mobile application, a dedicated mobile device or tablet, or cloud, or personal computer.

Through the implementation of the management system 100, automatic preventive maintenance can be put in place, and critical parts of the cranes would not require onsite access, especially the Jib walks, the hoisting and the luffing drums. Further, the system would be able to identify errors and faults with greater efficiency and accuracy, and in some cases begin to take preventive action. This would improve crane operating time and reduce breakdowns and down time, and possibly lengthen the operational life of the crane, especially with the sensors that monitor the various components and the ability to provide an accurate diagnosis, either through system analysis or remote assessment.

Other information such as the available configurations of the crane are also captured and presented by the system if required. The information and data from a crane can also be customized to provide specific data for each client to allow them to visualize the crane in operation.

One part of the system is the “Black Box” database, whose function is to record a compilation of all data at regular intervals, which can be set from previous set time span (X minutes) and available for interrogation should a catastrophe or an event should occur. This also allows the performance of a particular crane to be reviewed through its history. This also allows for a real time diagnostic analysis of the crane incorporating off site technicians with various specialties and expertise (inducing EOM expertise) to combine their skills to fix any technical errors or malfunctions that may occur.

Other parts of the systems can include:
a. Optimization of crane operations through real time planning and management for daily job schedules.
b. Logging crane downtime and using data to plan future work more effectively
c. Schedule maintenance programs/climbs into the work schedule from off-site office or portable PC's including mobile phones.
d. Monitor anti-collision systems and synchronize the crane movements to ensure upmost safety and efficiency.

The information captured includes general information for each crane including its location, contact information, and settings for the crane. Also captured or logged can be events involving the crane, like movement direction, height, trolley/luffing, slewing, wind speed and direction, temperature, and reeving, as well as alarm logs, and storm brace mechanism. This information captured can be delivered in a view mode only to prevent inadvertent or unwanted changes and allow remote monitoring safely.

The arrangement of FIG. 4 allows remote monitoring of a crane management system. This allows a company or a client to check on the progress at a construction site. Alerts and alarms are triggered when safety of the crane is compromised. Given that this can occur through a myriad of situations, having this automated, along with a review process, ensures safety on the worksite. Service records trigger regular maintenance cycles. This prevents worn out parts from being a liability in the crane through regular checks and inspections.

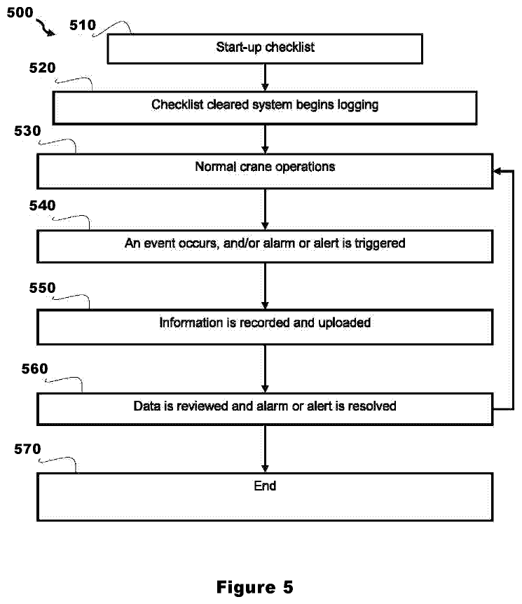

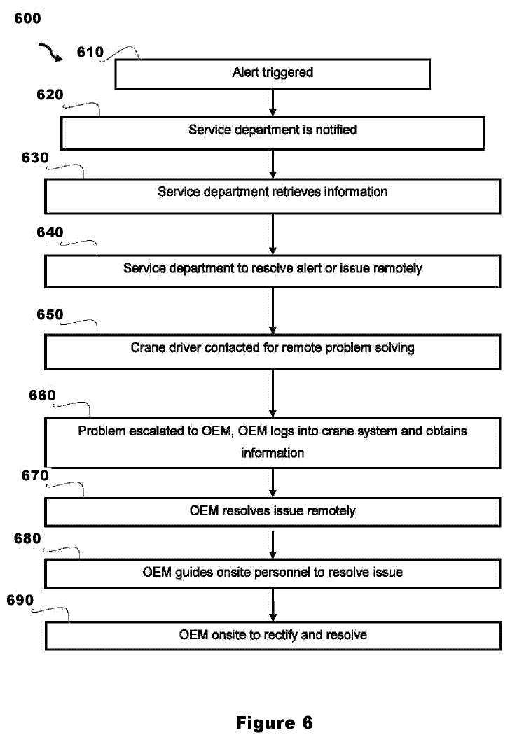

FIGS. 5 and 6 illustrates a high-level flow chart of operations illustrating logical operational steps of a method for managing a crane system, in accordance with the disclosed embodiments. It can be appreciated that each of the steps or logical operations of the method depicted can be implemented by executing a program instruction or a group of instructions in the management system.

The method 500 starts with a start-up checklist 510 and this can be done by the system itself with verification from the crane operator, or a hands-on checklist with various components confirmed to be operational before commencing operations, and the system begins logging 520 the normal crane operations 530. Should an event occur in the form of an alert or alarm 540, notification would be sent via email or telephone communication systems to relevant parties (dependent on the type of alert), and all the data or information is recorded and saved, in some cases uploaded 550 to a cloud or online server. This would enable the data to be reviewed and have the problem associated with the alarm or alert resolved 560. This would provide an aircraft style black box system for determining the cause of any fault or catastrophe.

With the information all in a single place, it would be easy for one skilled in the art to use this as described previously or in any other way that can be envisaged. A further feature of the system is the combination of this myriad of fields of information to derive conclusions or pre-emptive predictions, for example, once the pre-start check-list has been completed and a misalignment is detected in the hoist termination pin, either through sensors, image recognition, or even human intervention alert, the crane is shut down using an emergency shut down procedure and an urgent alert is sent out to various parties, including the service team. In another scenario, where the system detects that the clamp break is not opening, and that there are no encoder pulses, the outcome is that the system assumes that the variable frequency drive (VFD) has dropped out on safety, and highlights this accordingly. The system can even take the appropriate action to rectify if needed. Other applications of this analysis of collated information can use the temperature of the motor with the data relating to wind speed in order to determine the true operating temperature of the various motors present on the crane. For warning lights, if the system determines that the aviation light switch break is on, and the aviation light is not operating, either through sensors, image recognition, or even human intercession, and whether it is daylight or night time, the system would know that the aviation lights need to be changed and either do so if the crane hardware allows it, or alerts the crane operator/service team to do so. These non-limiting examples or rules can either be programmed into the system, or a learning algorithm is able to determine or even create such rules based on historical data and the desired outcomes or decisions, or the associated pattern recognition analysis. This means that the system would be able to provide real time diagnosis of any issues and even predict or pre-empt potential issues based on the conditions from the data collected.

An exemplary flow diagram of a method 600 the system employs to handle a maintenance, service, or breakdown alert is shown in FIG. 6, which begins when an alert is triggered by the system 610. The relevant service department is notified via email, text message, or system alert 620 and the service department would gather or access the alert information, together with the crane logs and data as well as real time readings to determine the cause of the fault 630, and where possible, a technician may resolve the problem remotely 640 by accessing the crane directly or even the relevant components to deal with the issue. If onsite assistance is required, the service department or technician may contact the authorized crane driver either through the system (system messaging service) or conventional communication channels to resolve the issue remotely 650. If not possible, the issue may be escalated to the original equipment manufacturer (OEM), who may have access to additional information and/or control of the crane, and obtains the information 660 and either resolves it remotely 670 or guides onsite personnel to fix the problem 680. In the extreme scenario, the OEM may have to dispatch someone onsite to rectify and resolve the issue 690.

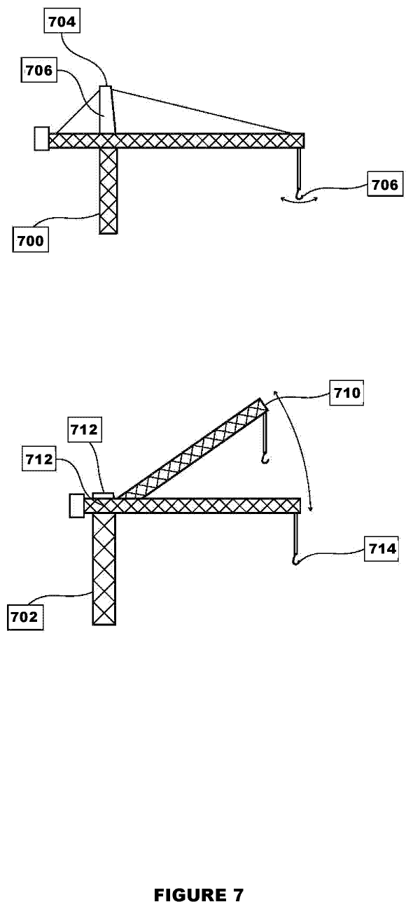

FIG. 7 is a schematic diagram of two cranes and indicates respective sensors on the cranes including stationary cameras 704 and 712, sensors reading wind speed 706 and 616 a LMI sensor sensing a radius of the crane hook, height and weight on the hooks 708 and 714 and an active camera 710 that moves with the Jib and includes a sensor for luff angle and height.

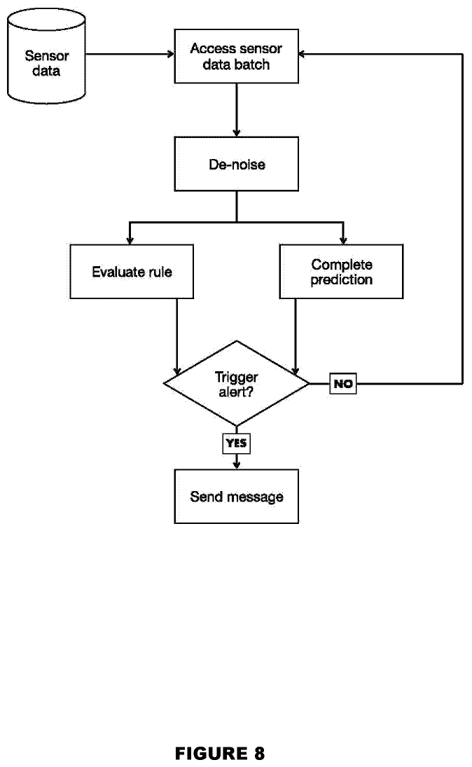

FIG. 8 is a flow diagram of a method of operation at the construction site management apparatus 100 of FIG. 1. The sensor data 804 is available in a store and the process accesses a sensor data batch 800 and de-noises 802 the sensor data by averaging or subtracting out noise using calibration data. The de-noised sensor data is used to evaluate one or more rules 806 and/or compute a prediction 808. In response to evaluation of a rule or computation of a prediction an alert is triggered 810 and a message sent 812. The message is a control message sent direct to equipment on the construction site and/or a message to a client device.

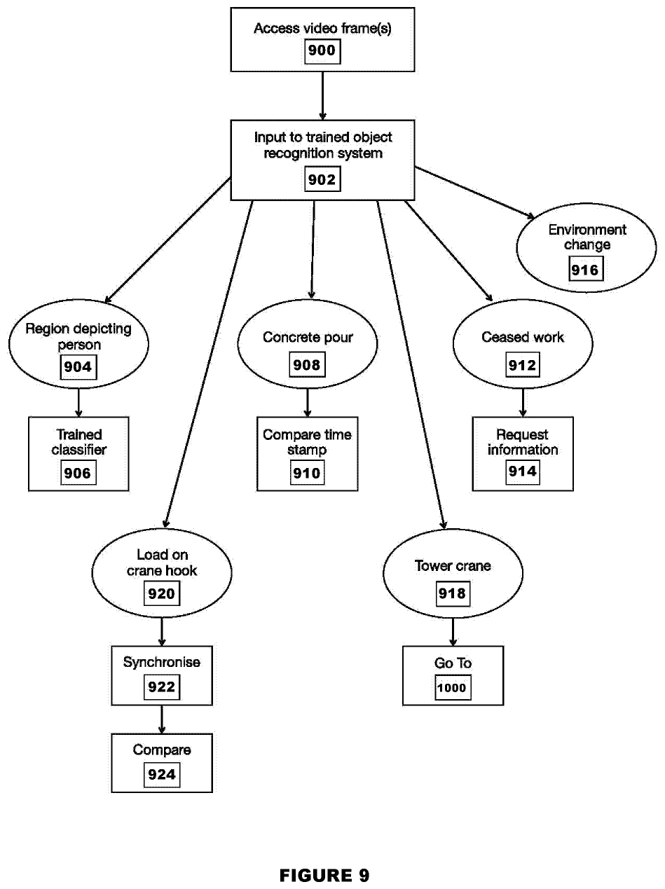

In some cases the sensor data comprises video and the process of FIG. 9 is used whereby one or more video frames are accessed 900 and input to a trained object recognition system 902. The object recognition system 902 is a convolutional neural network or other trained object recognition system. In some cases the object recognition system has been trained to detect people depicted in the video frames and to output one or more regions 904 depicting a person. In this case the region depicting a person is input to a trained classifier 906 which classifies the region as depicting personal protective equipment or not.

In some cases the object recognition system 902 has been trained to detect 920 presence of a load on a crane hook. In the case such a load is detected a synchronization step is carried out to synchronize the video frames with sensor data from an LMI sensor of the associated crane. Once synchronization is successful a comparison is done 924 between the load sensed at the crane hook in the presence of the visually detected load and the load sensed at the crane hook in the absence of the visually detected load. The comparison data is stored together with the video frames.

In some cases the object recognition system 902 has been trained to detect a concrete pour event 908 at the construction site. When a concrete pour event is detected a comparison is made between a time stamp of the video frame in which the concrete pour event is depicted and an expected time. Any discrepancy is stored and sent in a message together with the video frame to a site manager.

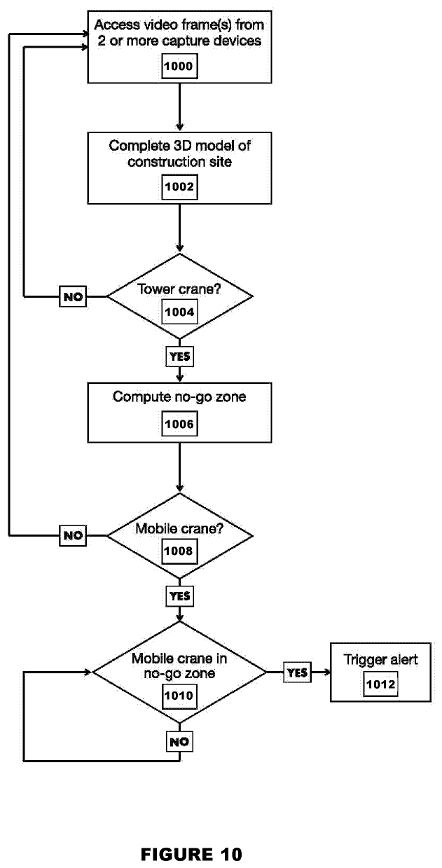

In some cases the object recognition system 902 has been trained to detect a tower crane 918. In this case the process moves to operation 1000 of FIG. 10.

In some cases the object recognition system 902 has been trained to detect ceased work 912 at the construction site. A request for information 914 is then sent to a site manager or other operative.

In some cases the object recognition system 902 has been trained to detect an environment change 916 such as a change in a tree, an oil spill, a waste dump.

FIG. 10 is a flow diagram of a method at the construction site management system in some examples. Video frames are accessed from three or more capture devices 1000. A 3D model of the construction site is computed 1002 from the video frames using conventional methods. If a tower crane has been detected in the process of FIG. 9 then check 1004 leads to operation 1006 whereby a no-go zone is computed around the tower crane in the 3D model. If a mobile crane is detected at check 1008, by using the object recognition system of FIG. 9, then a check is made at operation 1010 as to whether or not the mobile crane will enter the no-go zone. If yes, then an alert is triggered 1012 and/or control messages are sent to the mobile crane and the tower crane to disable them until safety has been restored.

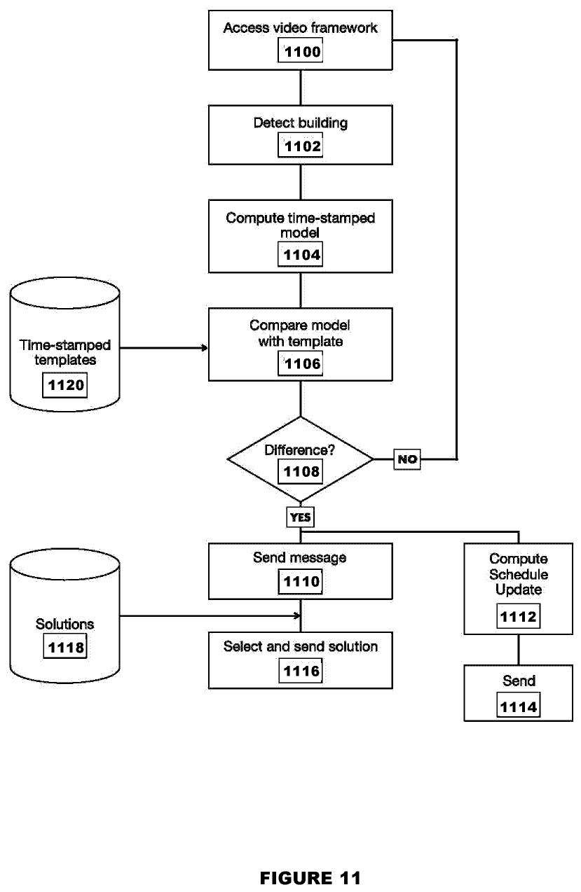

FIG. 11 is a flow diagram of a method of operation at a construction site management apparatus for gap analysis and remediation. Video frames 1100 are accessed and a building is detected 1102 in the video frames using the object recognition system of FIG. 9, or by using edge detection and template matching. A time stamped 2D model of the detected building is computed 1104 from the video frames by extracting a region depicting the building. The model is compared 1106 with a template. The template has a time stamp corresponding to the time stamp of the model. The template is obtained from a store 1120 of time stamped templated provided in advance. If a difference is found a message is sent 1110 to one or more client devices. Optionally an updated schedule is computed 1112 where the updated schedule takes into account the difference found at operation 1108. The updated schedule is sent 1114 to client devices of all those involved with the construction site project.

In some cases a database of solutions 1118 is available. The construction site management system selects one of the solutions which is appropriate to resolve the detected difference and sends 1116 the solution to client devices of all those involved with the construction site project.

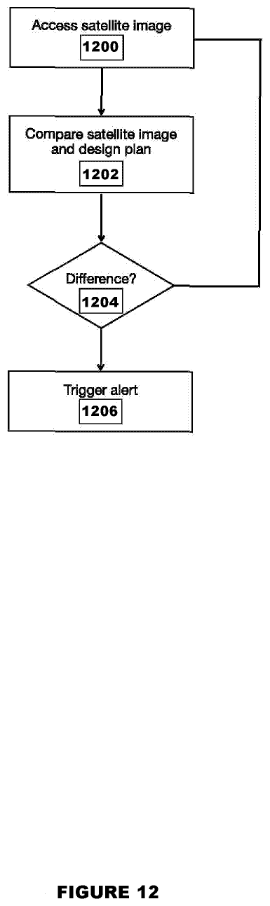

FIG. 12 is an exemplary flow diagram of a method of use of satellite images Where satellite images are available these are accessed 1200 and compared 1202 with a design plan. Scaling is used to scale the satellite image to the same scale as the design plan before making the comparison. Any difference greater than a specified threshold is detected at operation 1204 and triggers an alert 1206 to client devices of those involved with the construction site project. In some cases, when an alert 1206 is triggered, an upgrade to project architectural plans is also triggered in order to take into account the detected difference. In some cases any difference which is known, from pre specified rules or criteria, to result in a significant problem in the future, triggers an alert. When an alert 1206 to a client device is triggered the alert may comprise information about the gravity of the problem and may or may not include a proposed solution.

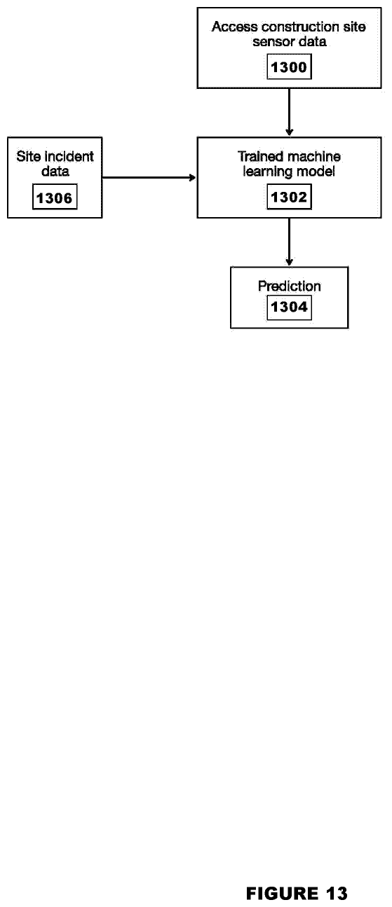

FIG. 13 is an exemplary flow diagram of a method of predicting an occupational health and safety accident. In an example machine learning is used to predict the likelihood of an occupational health and safety accident occurring at the construction site. Information about past site incidents at the construction site is available in store 1306 and comprises sensor data values from all available capture devices at the time of the site incident. Current construction site sensor data 1300 is input to a trained machine learning model 1302 together with the site incident data 1306. The trained machine learning model 1302 computes a prediction of likelihood of an occupational health and safety accident occurring at the construction site.

The machine learning model is a neural network of any suitable type and has been trained using sensor data collected from other construction sites and where the sensor data is labelled as being associated with an occupational health and safety accident or not. The training is done using back propagation in a conventional manner.

In an example a trained machine learning system is used to process the sensor data about the construction site and to compute predictions from the sensor data. The computed predictions are any one or more of: the likelihood of an occupational health and safety accident occurring at the construction site, deviation from a planned schedule of activities at the construction site, deviation from an expected design plan or other prediction.

The trained machine learning system is used together with a rule base having rules about how to modify a critical path of a construction project at the construction site. The predictions are used to resolve the one or more rules in real time and compute, in real time, a suggested modification to the critical path. Outputs of the trained machine learning system and the rule base, as well as information from the sensor data, are used to send reports to client devices. In this way it is possible to report and monitor progress of construction activities to key people who “need to know” through the lifetime of a construction project. At the end of a construction project the outputs of the machine learning system as well as records of the sensor data are stored in an “as built” file for the completed construction project.

The machine learning model is a neural network of any suitable type and has been trained using sensor data collected from other construction sites and where the sensor data is labelled according to whether it is associated with one or more of: the likelihood of an occupational health and safety accident occurring at the construction site, deviation from a planned schedule of activities at the construction site, deviation from an expected design plan or other event. The training is done using back propagation in a conventional manner.

As understood by one of ordinary skill in the art, the present invention can be implemented with special purpose computers, devices, and servers that are programmed to implement the embodiments described herein. Further, the system according to the embodiments disclosed herein is able accommodate many more combinations and permutations, or any other future electronic payment methods. For example, the system according to the embodiments disclosed herein can accommodate cloud based or app-based record management system as well.

Thus, the present invention has been fully described with reference to the drawing and figures. Although the invention has been described based upon these preferred embodiments, to those of skill in the art, certain modifications, variations, and alternative constructions would be apparent, while remaining within the spirit and scope of the invention. In order to determine the metes and bounds of the invention, therefore, reference should be made to the appended claims.

1. An apparatus for managing a construction site and/or crane, the apparatus comprising:
a memory storing sensor data received from a plurality of capture devices associated with the construction site and/or crane;
the memory storing one or more rules or thresholds;
a processor configured to process the sensor data by evaluating at least one of the rules, or by comparing a prediction computed from the sensor data with at least one of the thresholds;
the processor configured, in response to evaluation of a rule, or in response to comparison of a prediction with a threshold, to trigger an alert.

2. The apparatus of claim 1 wherein:
the memory stores a schedule of activities forming a critical path of a construction project at the construction site;
the sensor data comprises information about the activities;
the processor is configured to detect differences between the schedule of activities and the information about the activities from the sensor data; and
in response to detecting differences, the processor is configured to mitigate risks by following one or more rules according to the detected differences.

3. The apparatus of claim 2 wherein the processor is configured to send a message comprising the information about the activities and the detected differences to one or more end user devices in real time.

4. The apparatus of claim 1 wherein the sensor data comprises video received from at least one capture device having a field of view including at least part of the construction site and wherein the processor is configured to carry out image processing on one or more frames of the video in order to evaluate at least one of the rules.

5. The apparatus of claim 4 wherein the image processing comprises detecting people depicted in the video by inputting the video to a trained object recognition system, and for each detected person, to input a region of the video depicting the person to a trained classifier, which classifies the region as depicting personal protection equipment or not.

6. The apparatus of claim 5 comprising, in response to the classifier classifying a region as not depicting personal protection equipment, triggering the alert by triggering a message to be sent to a specified destination, the message comprising an image of the region input to the trained classifier.

7. The apparatus of claim 4 wherein the video is received from two or more capture devices and wherein the image processing comprises computing a 3D model of the construction site.

8. The apparatus of claim 7 wherein the image processing comprises detecting a tower crane by inputting the video to a trained object recognition system, and computing a no-go zone around the tower crane in the 3D model of the construction site.

9. The apparatus of claim 8 wherein the image processing comprises detecting a mobile crane by inputting the video to the trained object recognition system, and wherein the processor is configured to evaluate a rule by checking if the detected mobile crane is in the no-go zone of the 3D model.

10. The apparatus of claim 1 wherein the sensor data comprises video received from at least one capture device having a field of view including at least part of the construction site and wherein the processor is configured to carry out image processing to detect a building being built at the construction site and to compute a timestamped model of the building; the processor configured to evaluate at least one of the rules by comparing the model with a template having a corresponding timestamp.

11. The apparatus of claim 10 wherein the processor is configured, in response to the comparison identifying a difference between the model and the template, to send a message comprising information about the difference and including one or more frames of the video.

12. The apparatus of claim 11 wherein the processor is configured to access a database of solutions and to select one of the solutions on the basis of the difference, and to send the solution as part of the message.

13. The apparatus of claim 1 wherein the sensor data comprises video received from at least one capture device having a field of view including at least part of the construction site and wherein the processor is configured to carry out image processing to detect a concrete pour by inputting the video to a trained object recognition system.

14. The apparatus of claim 13 wherein the processor is configured to evaluate one of the rules by comparing a time stamp of a frame of the video depicting the concrete pour with a specified time, and in response to the comparison indicating a difference bigger than a threshold amount, sending a message comprising the difference and one or more frames of the video.

15. The apparatus of claim 1 wherein the sensor data comprises video received from at least one capture device having a field of view including at least part of the construction site and wherein the processor is configured to carry out image processing to detect cease of building work at the construction site and in response, to request information from a human.

16. The apparatus of claim 15 wherein the sensor data comprises information about weather at the site and information about road traffic around the site; and wherein the processor selects a solution from a database of solutions according to the sensor data and information received from a human operator.

17. The apparatus of claim 10 wherein the processor is configured, in response to the comparison identifying a difference between the model and the template, to compute an update to a schedule and send the updated schedule to members of a labor force.

18. The apparatus of claim 4 wherein the image processing comprises detecting one or more of: fuel spillage, tree damage, waste disposal, by inputting the video to a trained object recognition system.

19. The apparatus of claim 1 wherein at least one of the capture devices is a satellite and wherein the processor is configured to evaluate one of the rules by comparing a design plan with one of more images from the satellite depicting the construction site.

20. The apparatus of claim 1 wherein at least one of the capture devices is either:
a stress sensor within a building being constructed at the construction site and wherein the processor is configured to evaluate one of the rules by comparing data from the stress sensor with a threshold; or
a sensor measuring reduced level, which is a vertical distance between a survey point and an adopted datum plane, and wherein the processor is configured to evaluate one of the rules by comparing data from the sensor measuring reduced level with a target value from a stamped design of a building being constructed at the construction site.

21. The apparatus of claim 4 wherein at least one of the capture devices is a load-moment indicator or strain-gauge of a crane at the construction site and wherein the processor is configured to:
detect reinforcing metal carried on a hook of the crane by inputting the video to an object recognition system;
synchronize sensor data from the load-moment indicator or strain gauge with the video; and
compare data from the load-moment indicator or strain gauge at the time the reinforcing metal is detected, with data from the load-moment indicator when the reinforcing metal is absent from the crane hook.

22. The apparatus of claim 1 wherein the prediction is a prediction that an occupational health and safely accident is likely to occur at the construction site and where the prediction is computed from the sensor data by inputting the sensor data to a trained machine learning model together with information about one or more site incidents which have occurred at the construction site, the machine learning model having been trained using historical sensor data and historical site incident data from other construction sites.

23. The apparatus of claim 1, wherein:
the construction site comprises a crane system; and
the one or more rules or thresholds relate to at least one operation of the crane system.

24. The apparatus of claim 23, wherein:
the memory further stores a schedule of operations of the crane system;
the sensor data comprises information about the operations of the crane system;
the processor is further configured to detect differences between the schedule of operations of the crane system and the information about the operations of the crane system from the sensor data; and
in response to detecting differences, the processor is configured to follow one or more actions according to the detected differences.

25. The apparatus of claim 24 wherein the processor is further configured to send a notification comprising the detected differences to a user device in real time.

26. The apparatus of claim 23 wherein the sensor data further comprises video data from at least one capture device, the video data depicting at least part of the crane system or at least part of an environment in the vicinity of the crane system and wherein the processor is configured to perform image processing on one or more frames of the video in order to evaluate at least one of the rules or thresholds.

27. The apparatus of claim 23 wherein the sensor data comprises motion data from at least one capture device providing information about the movement of the crane system and wherein the processor is configured to process the motion data in order to evaluate at least one of the rules or thresholds.

28. The apparatus of claim 27 wherein the motion data is time-stamped and includes an amount of load carried, radius, and environmental conditions.

29. The apparatus of claim 23 wherein the sensor data comprises image depicting a termination rope of a tower crane and wherein the rules or thresholds relate to correct termination of the termination rope or to presence of abnormality in the termination rope.

30. The apparatus of claim 23 wherein the sensor data comprises data relating to aviation lights of a crane and wherein the rules or thresholds relate to correct operation of the aviation lights.

31. The apparatus of claim 23 configured to automatically generate a crane monitoring diagram providing an overview of the sensor data and a crane.

32. The apparatus of claim 23 wherein the rules or thresholds relate to a misalignment in a hoist termination pin of a crane, and wherein the apparatus is configured, in response to the rules or thresholds being triggered, to send instructions to have the crane shut down using an emergency shut down procedure and to send an alert to specified addresses.
